(19) United States
(12) Patent Application Publication
(10) Pub. No.: US 2016/0324332 A1
(43) Pub. Date: Nov. 10, 2016

(54) Child Receptacle Cover

(71) Applicant: Jennifer Jacobsen, Littleton, CO (US)

(72) Inventor: Jennifer Jacobsen, Littleton, CO (US)

(21) Appl. No.: 15/147,278

(22) Filed: May 5, 2016

Related U.S. Application Data
(60) Provisional application No. 62/158,231, filed on May 7, 2015.

(51) Int. Cl. A47D 15/00; A47D 13/02; B60N 2/28

(52) U.S. Cl. CPC A47D 15/00; B60N 2/2845; A47D 13/025

(57) ABSTRACT

A child receptacle cover for use with an apparatus defining a child receptacle, for example a child car seat of the type that has a carrying handle configured to be suspended over a child receptacle. The child receptacle cover comprises a flexible sheet which is sized least cover the child receptacle. A first portion of the flexible sheet may be formed of a flexible barrier panel. A second portion of the flexible sheet may be formed of at least one flexible mesh panel. The at least one flexible mesh panel may be covered by at least one flexible barrier flap.

### RELATED APPLICATIONS

This application claims priority from U.S. Provisional Patent Application Ser. No. 62/158,231, filed May 7, 2015, entitled “Car Seat Cover,” which is hereby incorporated by reference.

### TECHNICAL FIELD

The present disclosure is directed towards a child receptacle cover and more particularly a child receptacle cover for use with an apparatus defining a child receptacle, for example, a child car seat.

### BACKGROUND

Traditionally, car seat covers for infants have made a tradeoff between creating a relaxing atmosphere for the infant while still allowing air to flow easily through the car seat. As a result, car seat covers are designed to either provide a relaxing environment for the infant or to allow air to easily flow throughout the car seat. A need remains for a car seat cover that can provide a relaxing environment while still allowing for the easy flow of air.

The present embodiments described herein is intended to overcome the problems discussed above.

### SUMMARY

A first aspect is a child receptacle cover for use with an apparatus defining a child receptacle, for example, a child car seat. The car seat may be of the type that has a carrying handle configured to be suspended over a child receptacle. The child receptacle cover comprises a flexible sheet which is sized to at least cover the car seat. A first portion of the flexible sheet may be formed of a flexible barrier panel. A second portion of the flexible sheet may be formed of at least one flexible mesh panel. The at least one flexible mesh panel may be covered by at least one flexible barrier flap. The at least one flexible barrier flap may be attached to the mesh panel along an outer length-wise edge of the flap. The flexible barrier flap may then be draped from its outer edge to cover the at least one flexible mesh panel. Further, the flexible barrier flap may extend slightly beyond each flexible mesh panel. The flexible barrier panel and the flexible barrier flap may be formed of a material that inhibits the penetration of light or water.

The child receptacle cover may further include a fastener to securely suspend the flexible sheet from a car seat handle. The fastener may be at least one of a hook and loop connector, a strap having a hook and eye connector, a strap having a button and buttonhole connector, a strap having a snap connection or cords which can be tied together or joined by a connector for forming a loop around the car seat handle.

In another embodiment the flexible mesh sheet may have at least four flexible mesh panels. A flexible barrier flap may be configured to correspond with each flexible mesh panel.

Another aspect is a method of making a child receptacle cover. The method includes forming a flexible sheet by attaching at least one flexible barrier panel to at least one flexible mesh panel. At least one flexible barrier flap may then be attached to the at least one flexible mesh panel such that the flexible barrier flap covers the flexible mesh panel. The at least one flexible barrier flap may be attached along a length-wise outer edge to the at least one flexible mesh panel. Once the flap is attached it may be draped over the mesh panel to cover the mesh. The flexible sheet may then be sized to ensure that it covers a child receptacle.

When a flexible barrier flap is configured to cover the at least one flexible mesh panel, an occupant of the child receptacle can enjoy both a relaxing and a well-ventilated environment. Further, by adding a flexible barrier flap over a mesh panel, light or water may be prevented from penetrating the interior of the child receptacle through the mesh. This ensures the occupant of the child receptacle will not be disturbed.

### BRIEF DESCRIPTION OF THE DRAWINGS

FIG. 1 is a top, front perspective view of an embodiment of a child receptacle cover in accordance with the present disclosure.

FIG. 2 is a top, rear perspective view of the child receptacle cover of FIG. 1.

FIG. 3 is a bottom, front perspective view of the child receptacle cover of FIG. 1.

FIG. 4 is a top, left side perspective view of the child receptacle cover of FIG. 1 disposed over a car seat of the type having a carrying handle.

FIG. 5 is a top, front perspective view the car child receptacle of FIG. 1 disposed over a car seat of the type having a carrying handle.

### DETAILED DESCRIPTION

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

The present disclosure is directed to child receptacle cover for use with an apparatus defining a child receptacle. For ease of illustration, the disclosure is specifically geared to a car seat cover for use with a child car seat, but this specific example is not intended to be limiting on the scope of the disclosure, the scope of the claims or the types of apparatus defining a child receptacle with which the child receptacle cover can be deployed

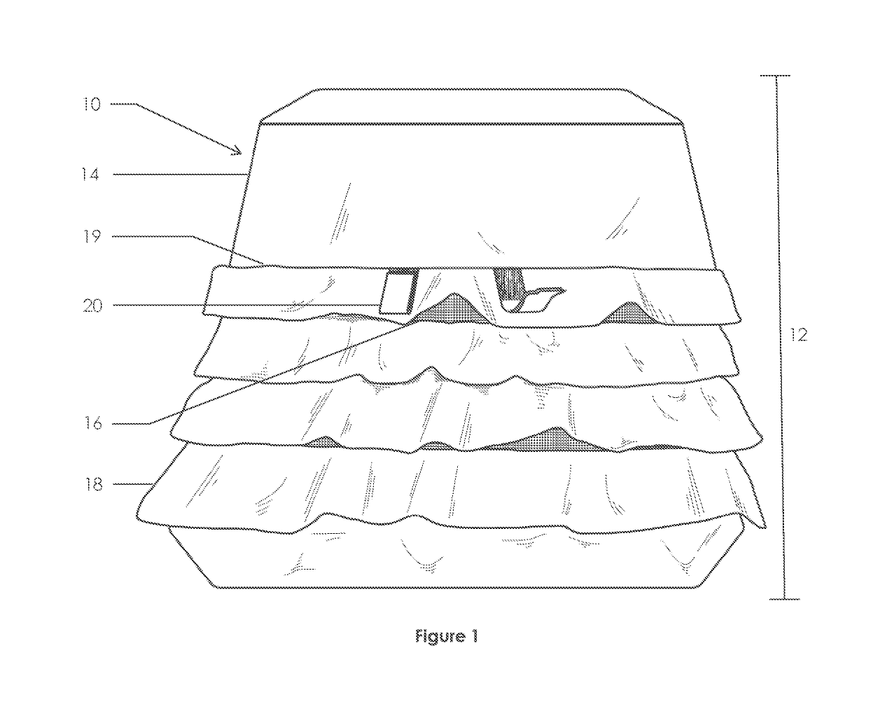

A top, front perspective view of a fully assembled child receptacle cover, more particularly a car seat cover 10 is illustrated in FIG. 1. The car seat cover 10 is made up of a flexible sheet 12 which is sized to cover a car seat of the type that has a carrying handle configured to be suspended over a child receptacle. The flexible sheet 12 may be formed by attaching at least one flexible barrier panel 14 to at least one flexible mesh panel 16. At least one flexible barrier flap 18 may be configured to overlay the mesh panel 16.

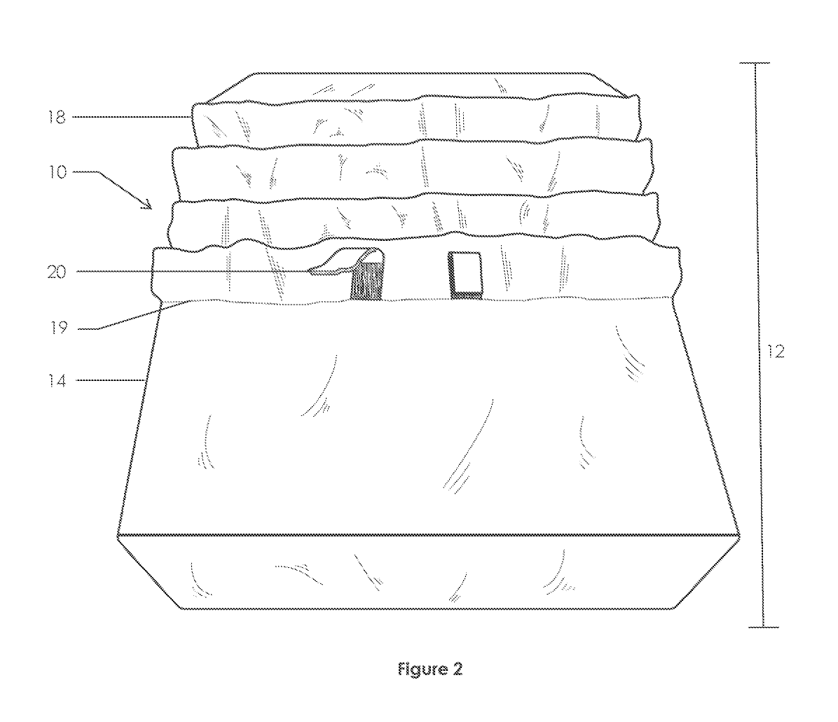

The car seat cover 10 may be sized to fit the car seat exactly or have some material hang slightly over the side of the car seat. By sizing the car seat cover 10 to hang over the sides of the car seat, the car seat cover 10 may fit most infant car seats and the occupant may be shielded from the external environment. The flexible sheet 12 may be formed using different proportions of the flexible barrier panel 14 to the flexible mesh panel 16. For example, in the illustrated embodiments shown in FIGS. 1 and 2, about half of the flexible sheet 12 is formed from the flexible barrier panel 14 and the other half is formed from the flexible mesh panel 16. However, these proportions should not be limited to just half and half. Further, although it is not shown in the figures, the flexible sheet 12 of the car seat cover 10 may be made entirely of the at least one flexible mesh panel 16. At least one flexible barrier flap 18 may then be configured to overlay the entire flexible sheet 12 formed of the at least one flexible mesh panel 16.

The flexible barrier panel 14 and the at least one flexible barrier flap 18 may be made from a material that inhibits the penetration of light or water into the car seat. The flexible barrier panel 14 and the at least on flexible barrier flap 18 may be formed from the same material or from different types of materials for inhibiting light or water.

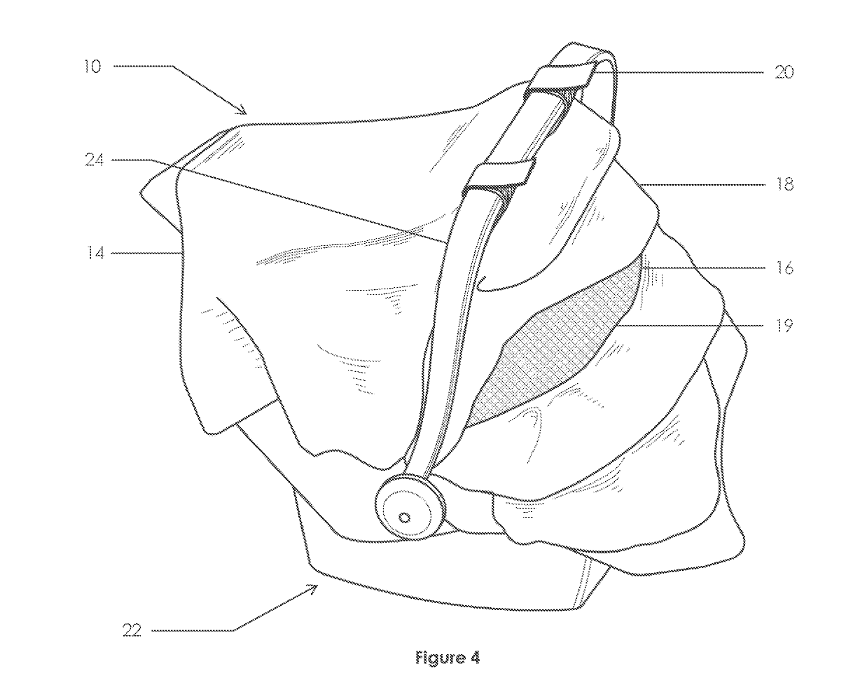

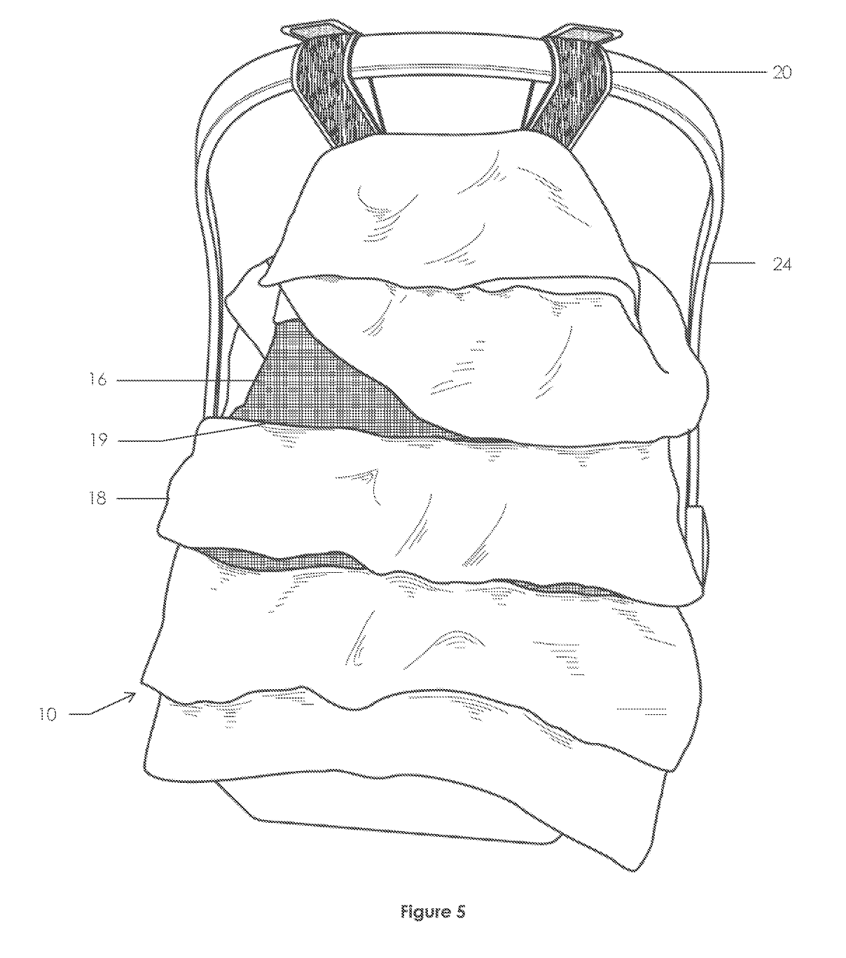

The at least one flexible barrier flap 18 may be attached to the mesh panel 16 along a single length-wise edge 19 of the at least one flexible barrier flap 18. The at least one flexible barrier flap 18 may then be draped over the at least one flexible mesh panel 16 with the car seat cover 10 deployed on a car seat 22, as illustrated in FIGS. 4 and 5. The at least one flexible barrier flap 18 may be sized to extend slightly beyond each flexible mesh panel 16 to ensure that light, water, or other material to be inhibited does not enter the interior of the car seat 22. Further, the at least one flexible barrier flap 18 may be ruffled along an opposite single length-wise edge from the attachment 19 to create a better flow of air into and out of the interior of the car seat.

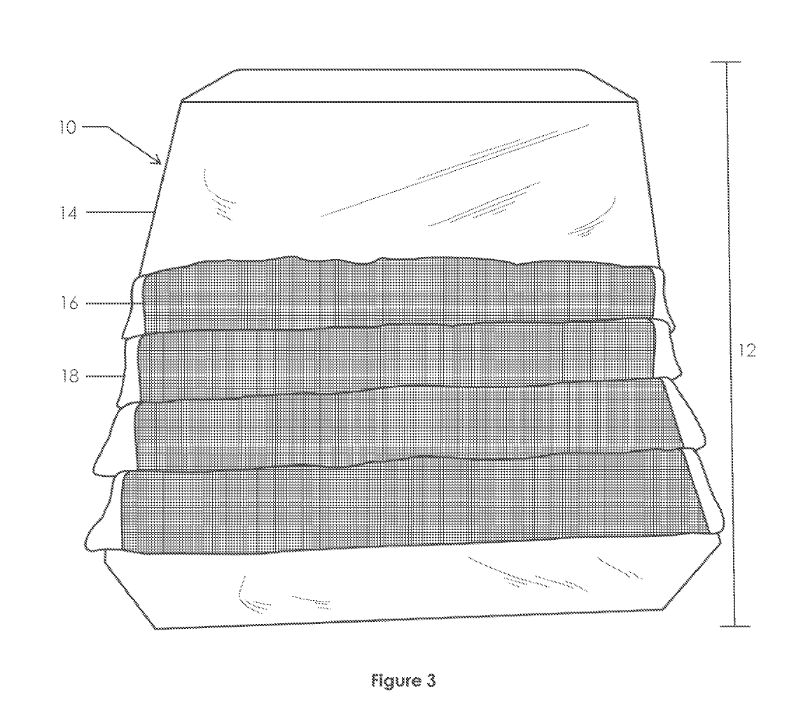

In another embodiment of the car seat cover 10 (best seen in FIG. 3, which represents a bottom, front perspective view of the car seat cover 10 of FIG. 1 with the barrier flaps cut away in part) the mesh 16 may be divided into four separate panels. There may be at least one flexible barrier flap 18 to correspond to each of the four mesh panels 16. The barrier flaps 18 may be configured to extend slightly beyond each flexible mesh panel 16 in order to ensure that there is a screen between the car seat occupant and the external environment.

FIGS. 4 and 5 depict views of the car seat cover 10 of FIG. 1 disposed over a car seat 22 of the type having a carrying handle 24. A barrier flap 18 is shown elevated to reveal a mesh panel 16 underlying the barrier flap 18. There are several different ways to attach the flexible sheet 12 to the car seat 22. The flexible sheet 12 may be draped over the car seat handle 24 without the use of fasteners. However, simply covering the car seat 22 with the flexible sheet 12 may cause the flexible sheet 12 to interfere with moving the car seat handle 24 up and down or it may interfere with fastening the car seat 22 into a car.

The car seat cover 10 may further include at least one fastener 20 for suspending the flexible sheet 12 from a car seat handle 24 (as shown in FIGS. 4 and 5). By suspending the flexible sheet 12 from the car seat handle 24, the car seat 22 may be easily secured in the car and the car seat handle 24 can more easily move up and down. The fastener 20 may comprise at least one of a strap having a snap connector, a strap having a hook and loop connector, a strap having a hook and eye connector, a strap having a button and buttonhole connector, cords which can be tied together or joined together by various connectors for forming a loop around the car seat handle 24 or any other suitable structure for attaching the flexible sheet to a car handle. The fastener 20 may be attached at the middle of the flexible sheet 12 as shown in the illustrated embodiments or elsewhere between the front and back ends of the flexible sheet 12 or may be attached at a transition from the flexible barrier panel 14 and a mesh panel 16.

The car seat cover 10 may further include a cinch around the perimeter of the flexible sheet 12 for fastening the perimeter of the flexible sheet 12 around a base of a car seat defining a child receptacle. The cinch may be any device suitable for maintaining the perimeter of the flexible sheet in place around the child receptacle including, but not by way of limitation, an elastic band, a chord received in a peripheral channel, the ends of which can be tied together or joined together by various connectors, or a strap received in a peripheral channel having a snap connector, a hook and loop connector, a hook and eye connector, or a button and buttonhole connector.

The car seat cover 10 disclosed herein may have application to a wide variety of other child receptacle apparatuses, including, but not limited to, bouncy chairs, strollers and cribs.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

What is claimed is:

1. A child receptacle cover for use with an apparatus defining a child receptacle, child receptacle cover comprising:
a flexible sheet sized to at least cover the child receptacle;
a first portion of the flexible sheet being formed of a flexible barrier panel; and
a second portion of the flexible sheet being formed of at least one flexible mesh panel; and
at least one flexible barrier flap configured to cover the at least one flexible mesh panel.

2. The child receptacle cover of claim 1 wherein the apparatus defining a child receptacle is a child car seat of the type having a carrying handle configured to be suspended over a child receptacle, the child receptacle cover further including a fastener for suspending the flexible sheet from a car seat handle.

3. The child receptacle cover of claim 2 wherein the fastener comprises at least one of a strap having a hook and loop connector, a strap having a hook and eye connector, a strap having a button and buttonhole connector, a strap having a snap connector or cords which can be tied together or joined by a connector for forming a loop around the car seat handle.

4. The child receptacle cover of claim 1, wherein the flexible barrier panel is formed of at least one of a light or water inhibiting material.

5. The child receptacle cover of claim 1, wherein the flexible barrier flap is formed of at least one of a light or water inhibiting material.

6. The child receptacle cover of claim 1, wherein the flexible barrier panel and the flexible barrier flap are made of the same material.

7. The child receptacle cover of claim 1, wherein the at least one flexible barrier flap is attached to the second portion of the flexible sheet along a single length-wise edge of the at least one flexible barrier flap, wherein the at least one flexible barrier flap is draped over the at least one flexible mesh panel with the child receptacle cover deployed on a child receptacle.

8. The child receptacle cover of claim 1, wherein the second portion of the flexible sheet is formed of at least four flexible mesh panels.

9. The child receptacle cover of claim 8, wherein there is at least one flexible barrier flap corresponding to each mesh panel.

10. The child receptacle cover of claim 1, wherein each flexible barrier flap extends slightly beyond each flexible mesh panel.

11. The child receptacle cover of claim 1, wherein each flexible barrier flap is ruffled along a single length-wise edge of the at least one flexible barrier flap.

12. The child receptacle cover of claim 1 further having a cinch around the perimeter of the flexible sheet configured to fasten the perimeter of the flexible sheet to the apparatus defining a child receptacle.

13. A method of making a child receptacle cover for use with an apparatus defining a child receptacle, the method comprising:
forming a flexible sheet by attaching a flexible barrier panel to at least one flexible mesh panel;
attaching at least one flexible barrier flap to the flexible sheet in a manner covering the at least one flexible mesh panel; and
sizing the flexible sheet to at least cover a child receptacle.

14. The method of claim 13 wherein the apparatus defining a child receptacle is a child car seat of the type having a carrying handle configured to be suspended over a child receptacle, the method further comprising attaching a fastener to the flexible sheet for suspending the flexible sheet from the car seat handle.

15. The method of claim 14 further comprising forming the fastener from at least one of a strap having a hook and loop connector, a strap having a hook and eye connector, a strap having a button and buttonhole connector, or a strap having a snap connector or cords which can be tied together or joined by a connector for forming a loop around the car seat handle.

16. The method of claim 13 further comprising:
attaching the at least one flexible barrier flap to the flexible sheet along a single length-wise edge of the at least one flexible barrier flap in a manner that the at least one flexible barrier flap drapes over the at least one flexible mesh panel with the child receptacle cover deployed on a child receptacle.

17. The method of claim 13 further comprising forming the flexible barrier panel is from at least one of a light or water inhibiting material.

18. The method of claim 13 further comprising forming the flexible barrier flap from at least one of a light or water inhibiting material.

19. The method of claim 13 further comprising making the flexible barrier panel and the flexible barrier flap out of the same material.

20. The method of claim 13 further comprising extending each flexible barrier flap slightly beyond each flexible mesh panel.

21. The method of claim 13 further comprising ruffling at least one flexible barrier flap along a single length-wise edge of the at least one flexible barrier flap.

22. The method of claim 13 further comprising attaching a cinch around the perimeter of the flexible sheet configured to fasten the perimeter of the flexible sheet to the apparatus defining a child receptacle.
